(19) United States
(12) Patent Application Publication
(10) Pub. No.: US 2009/0247426 A1
(43) Pub. Date: Oct. 1, 2009

(54) FOCUSED LIBRARY GENERATION

(75) Inventor: Pranav Patel, Fremont, CA (US)

Correspondence Address: PACIFIC BIOSCIENCES OF CALIFORNIA, INC., 1505 ADAMS DR., MENLO PARK, CA, 94025, US

(73) Assignee: Pacific Biosciences of California, Inc., Menlo Park, CA (US)

(21) Appl. No.: 12/413,811

(22) Filed: Mar. 30, 2009

Related U.S. Application Data
(60) Provisional application No. 61/041,158, filed on Mar. 31, 2008.

(51) Int. Cl. C40B 50/00

(52) U.S. Cl. 506/23

(57) ABSTRACT

The present invention relates generally to in vitro methods for generating mutant nucleic acid and polypeptide libraries. In particular, the present invention provides methods and compositions for mutagenesis and recombination of polynucleotide sequences in amplification methods that utilize primer oligonucleotides, and for expressing the resultant nucleic acid libraries to generate polypeptide libraries.

### CROSS-REFERENCE TO RELATED APPLICATIONS

This application claims benefit of Provisional U.S. Patent Application No. 61/041,158, filed Mar. 31, 2008, the full disclosure of which is hereby incorporated herein by reference in its entirety for all purposes.

### STATEMENT REGARDING FEDERALLY SPONSORED RESEARCH

Not Applicable.

### FIELD OF THE INVENTION

The present invention relates generally to in vitro methods for generating mutant nucleic acid and polypeptide libraries. In particular, the present invention provides methods and compositions for mutagenesis and recombination of polynucleotide sequences in amplification methods that utilize primer oligonucleotides. The present invention also provides methods and compositions for generating mutant nucleic acid libraries and then expressing those libraries to generate mutant polypeptide libraries.

### BACKGROUND OF THE INVENTION

Proteins are often genetically and molecularly manipulated to improve their performance for practical applications. For example, enzymes can be engineered to alter their specificity or to increase their catalytic capability. However, it can be difficult to specifically identify the residues that must be mutated to provide these characteristics. One approach to generating improved proteins is to create a library randomly mutated proteins. Such libraries can be used to screen for nucleic acids and proteins with desired characteristics.

A drawback to generating libraries using random mutagenesis is that such methods provide little control over how many and where in the primary structure of a protein mutations occur, resulting in libraries that contain large numbers of nucleic acids and proteins that are non-functional or have vital components removed or altered.

### SUMMARY OF THE INVENTION

Accordingly, the present invention provides methods and compositions for generating libraries of polynucleotides and polypeptides by conducting amplification reactions in which the positions at which mutations occur are focused through the use of specifically designed primers and reaction conditions.

In one aspect, the invention provides a method of producing a library of mutated nucleic acids. This method includes the steps of: providing a single-stranded template nucleic acid comprising a first sequence of nucleotides; providing a first set of primers, wherein a majority of the primers in that first set are perfectly complementary to at least a portion of the first sequence of nucleotides; providing a second set of primers, wherein a majority of the primers in that second set are complementary to at least a portion of the first sequence of nucleotides except for at least one pre-selected mismatched nucleotide complementary to at least one targeted mutation. This method further includes the steps of combining the template nucleic acid with the first set of primers and the second set of primers under conditions suitable for amplification of said template nucleic acid, and amplifying the template nucleic acid to produce a library of mutated nucleic acids, wherein the mutated nucleic acids in the library have at least one targeted mutation therein.

In another aspect, the invention provides a method of generating a library of polynucleotide molecules, wherein the polynucleotide molecules encode at least a portion of a mutant enzyme. In such an aspect, the method includes the step of contacting at least one single-stranded template polynucleotide with a set of primers, where the set of primers includes at least one primer perfectly complementary to at least a portion of the template polynucleotide. The single-stranded template is also contact with a plurality of mutant primers, wherein each of the plurality of mutant primers comprises at least one pre-selected mismatched nucleotide complementary to at least one targeted mutation. In this aspect, the method further includes conducting a multi-cycle polynucleotide extension reaction with the at least one template polynucleotide and the set of primers. In this multi-cycle extension reaction, in at least one cycle, the primers anneal to the at least one template polynucleotide and prime replication of the at least one template polynucleotide, thereby generating a pool comprising overlapping fragments, wherein the overlapping fragments are shorter in length than the at least one template polynucleotide and wherein the overlapping fragments overlap to span said at least one template polynucleotide molecule. In a subsequent cycle, the overlapping fragments generated in a previous cycle anneal in new combinations to the at least one template polynucleotide molecule, thereby forming annealed fragments, wherein the annealed fragments prime replication of the at least one template polynucleotide molecule to form a further pool of overlapping fragments. The multi-cycle polynucleotide extension reaction is continued for a sufficient number of cycles so that the further pool of overlapping fragments includes variant forms of the at least one template polynucleotide molecule. This process thus generates a library of polynucleotide molecules.

### BRIEF DESCRIPTION OF THE DRAWINGS

FIG. 1 is a schematic illustration of an embodiment of the invention.

FIG. 2 is a schematic illustration of an embodiment of the invention.

### DETAILED DESCRIPTION OF THE INVENTION

Unless defined otherwise, all technical and scientific terms used herein have the same meaning as commonly understood by one of ordinary skill in the art to which this invention belongs. All publications mentioned herein are incorporated herein by reference for the purpose of describing and disclosing devices, formulations and methodologies which are described in the publication and which might be used in connection with the presently described invention.

Note that as used herein and in the appended claims, the singular forms “a,” “an,” and “the” include plural referents unless the context clearly dictates otherwise. Thus, for example, reference to “a polymerase” refers to one agent or mixtures of such agents, and reference to “the method” includes reference to equivalent steps and methods known to those skilled in the art, and so forth.

Where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

In the following description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention.

### Overview

The present invention provides methods and compositions for generating libraries of mutant nucleic acids and polypeptides. In one aspect, these libraries are generated using a method in which a polynucleotide template is amplified using combinations of primers that introduce one or more targeted mutations into the resultant amplification products. Mutant nucleic acid libraries generated using such methods can in turn be expressed to generate corresponding mutant polypeptide libraries. Mutant nucleic acid and polypeptide libraries can be screened using methods known in the art and described further herein to identify molecules with desired characteristics.

In one aspect, the invention provides sets of primers in a polymerase chain reaction (PCR) to amplify a target polynucleotide template. In this aspect, at least some of the primers are perfectly complementary to the target polynucleotide template, except for at least one nucleotide which is pre-selected to not match the target sequence in an identified location. The amplification products that result from using such primers will thus contain at least one targeted mutation at a pre-selected location.

In one embodiment, the amplification reaction is structured such that each primer is only partially extended along the template sequence before the amplification cycle ends, e.g., due to the presence of another primer sequence hybridized to the template. This procedure results in a pool of fragments, many or most of which are shorter than the length of the template nucleotide. As multiple cycles proceed in a similar manner, the amplification products from a previous cycle will anneal to the template, will be extended by a number of nucleotides, and then will be removed. As different fragments and primers anneal to the template and are extended during the amplification reaction, recombination will occur, resulting in a pool of amplification products which contain one or more targeted mutations. As a result, a library of polynucleotide molecules is produced in which the polynucleotides contain mutations that have “evolved” from point mutations present in the original primers.

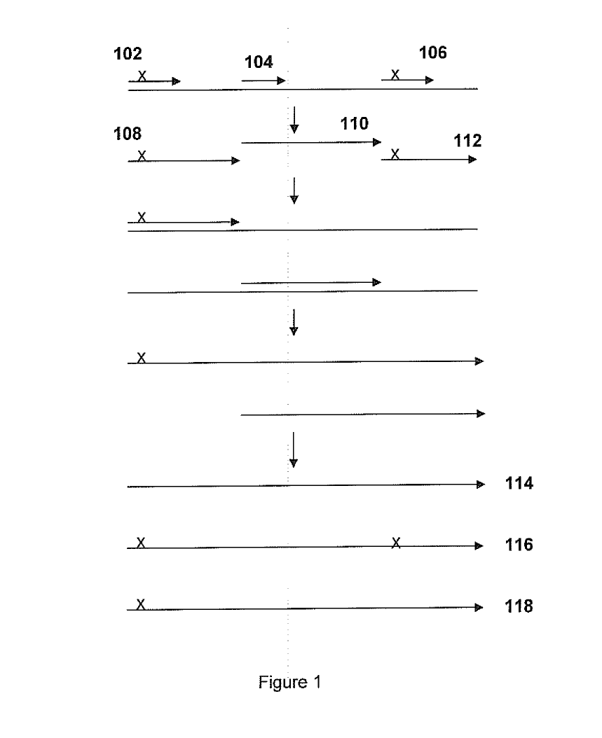

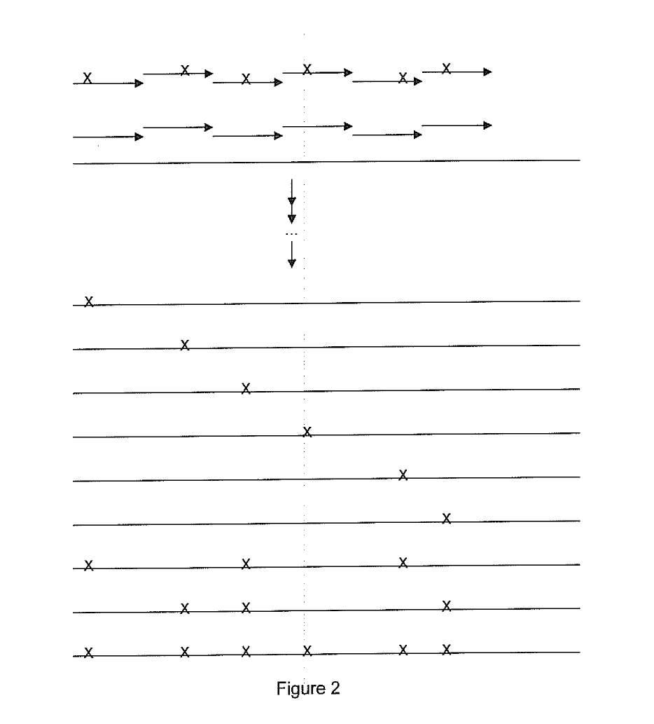

In one aspect, the evolution of mutations in a nucleic acid library of the invention is controlled by providing primers directed to regions of a nucleic acid that influence a functional characteristic of the encoded protein. Such primers are complementary to those regions of the nucleic acid sequence, but contain a pre-selected mutation at a nucleotide location complementary to a location within that region of the nucleic acid sequence. In one non-limiting example, such a pre-selected mutation can be made at a location in a primer that is complementary to a region of the nucleic acid encoding for an active site of an enzyme. Multiple cycles of amplification with such primers will result in polynucleotide molecules with targeted mutations that occur primarily in the pre-selected identified region. Mutant polynucleotide libraries generated in this manner may also contain random mutations in locations outside those targeted by primers of the invention. Exemplary embodiments of the methods of the invention are schematically illustrated in FIGS. 1 and 2.

In one exemplary embodiment pictured in FIG. 1, a template 100 is subjected to amplification in the presence of a mixture of primer sequences (e.g., primers 102, 104, and 106) that are complementary to different portions of the template. The mixture of primers will typically include at least two sets of primers, and at least a subset of each of the two sets of primers will be complementary to overlapping or identical regions of the template. The difference between the at least two sets of primers is that the primers in one set (the mutagenic set) will include one or more pre-selected mutations (indicated by X in FIG. 1). For purposes of illustration, the primer sets shows in FIG. 1 are not overlapping the same sequence regions of the template, but the invention is not limited to non-overlapping primers.

As illustrated in FIG. 1, amplification of the template sequence in the presence of the primers results in the production of fragments which are larger than the primers (e.g., fragments 108, 110, and 112). These fragments, as well as the original set of primers, then form the amplification complex for the subsequent round of amplification.

After a number of rounds of amplification and recombination, a set of full-length amplified sequences will be generated (e.g., products 114, 116, and 118) that bear each of the pre-selected (target) mutations alone or in any combination with the other mutations. Although only illustrated as a unidirectional amplification process in FIG. 1, it will be appreciated that a variety of amplification processes may be employed, including without limitation an antiparallel amplification with a polymerase chain reaction, a ligase chain reaction, and the like.

A further embodiment of the methods of the invention is illustrated in FIG. 2. In this embodiment, two complete sets of primer sequences are used that are complementary to the same regions of the template. Following multiple rounds of amplification with these sets of primers, multiple combinations of mutations are generated in the resultant library of amplification products.

In one embodiment, the template nucleic acids used to generate libraries of the invention encode for at least a portion of a protein. In one embodiment, the protein is an enzyme, such as a polymerase. In a further embodiment, the primers used in amplification reactions of the invention are directed to the part of the nucleic acid sequence corresponding to a particular region of the encoded protein, such as an active site of an enzyme.

In a further aspect, a library of mutant nucleic acids is expressed to provide a library of mutant polypeptides. In a still further aspect, this library of mutant polypeptides is screened for a desired characteristic.

### Focused Mutant Library Generation

In one aspect the invention provides methods for producing a library of mutated nucleic acids. Such a library can be generated by amplifying a template nucleic acid in an amplification reaction that utilizes primers containing at least one mis-matched nucleotide at a pre-selected position. As used herein, the term “nucleic acid” is used interchangeably with the term “polynucleotide” and “polynucleotide molecule”. The template nucleic acid can be single or double stranded, and may include a variety of general structures, including, e.g., circular and linear templates. Although generally described in terms of DNA templates, it will be appreciated that for different applications these templates may comprise DNA, RNA, and non-naturally occurring nucleic acids.

In one aspect, generating a library of mutated nucleic acids according to the invention includes providing two sets of primers for an amplification reaction. One set of primers (the “non-mutagenic” set) includes primers that are perfectly complementary to at least a portion of a sequence of the target nucleic acid. The second set of primers (the “mutagenic” set) also includes primers that are perfectly complementary to at least a portion of a sequence of the target nucleic acid, except for at least one mis-matched nucleotide. As a result of the mis-matched nucleotide within the mutagenic primers, an amplification reaction utilizing these primers will produce polynucleotides that contain one or more targeted mutations. As used herein, a “targeted mutation” is a mutation in a nucleic acid (and the polypeptide it encodes) that results from one or more cycles of an amplification reaction using a primer containing a mis-matched nucleotide at a pre-selected position. In one embodiment, mutagenic primers of the invention are designed to produce mutations within a nucleotide sequence of the nucleic acid that affects a functional characteristic of the encoded polypeptide.

In one aspect, an amplification reaction is conducted in which the template nucleic acid is combined with a mutagenic and a non-mutagenic set of primers. The mixture is incubated with an enzyme such a DNA polymerase and other reactants known in the art to promote template-based amplification. The primers anneal to the template nucleic acid at various positions along the template and are then extended to generate amplification products. In a further aspect, the amplification reaction is a multi-cycle reaction in which primers are allowed to anneal to the template nucleic acid, the primers are extended by a number of nucleotides (or nucleoside polyphosphates), and then the extended amplification products are removed and the hybridization/extension cycles are begun anew using the extended amplification products as primers and/or by adding new primers from the mutagenic and non-mutagenic sets of primers. In certain exemplary embodiments, extension products are ligated to form longer amplification products, generally prior to the removal of the extension products from the template nucleic acid. In further embodiments, these ligated extension products may be included in a later cycle of the amplification reaction. In other exemplary embodiments, each set of extension products is removed from the template before commencing the next round of amplification, and these extension products are not ligated to each other prior to being removed from the template.

In one embodiment, the cycles of the amplification reaction are structured such that the primers only partially extended along the template before they are removed from the template, resulting in pools of amplification products which are polynucleotides of shorter length than the template nucleic acid. As noted above, this is generally accomplished through the use of additional primer sequences hybridized downstream of the original primer. When a non-strand displacing polymerase enzyme is used, the downstream primer will force the polymerase to halt extension of the original primer.

In a further embodiment, the primers are extended in one or more cycles by enough nucleotides to cover the template nucleic acid by either a single extension product or by a combination of overlapping extension products. In one embodiment, the primers are extended in one or more cycles from about 1 to about 1000, from about 2 to about 10, from about 5 to about 20, from about 10 to about 50, from about 20 to about 250, from about 50 to about 500, from about 100 to about 1000 nucleotides. In another embodiment, the primers are extended in one or more cycles by more than 1000 nucleotides. The number of nucleotides by which primers are extended can be chosen based on the degree of diversity intended for the library of resultant mutant nucleic acids. The shorter the extension, the higher the diversity. As such, the minimum that primers added during one or more cycles of amplification reactions of the invention can be as low as 1, and the maximum can be (n-1), where n is the total number of nucleotides intended to be used for creation of the library. For libraries comprising nucleotide sequences encoding full-length proteins, n may be as high as several hundred thousand nucleotides.

In another embodiment, the production of short amplification products can be achieved in a variety of methods known in the art, including using polymerases such as the bacteriophage T4 DNA polymerase, or T7 sequenase DNA polymerase, Taq DNA polymerase, phi29 DNA Polymerase, Klenow, Vent DNA Polymerase, DNA Polymerase I, T4 DNA Polymerase, T7 DNA polymerase, Phusion Polymerase (New England BioLabs), and the like.

In a further embodiment, the pools of amplification products are of shorter length than the template nucleic acid but are overlapping, such that taken together, the amplification products span the entire length of the template.

In one aspect, mutant nucleic acid and polypeptide libraries generated as described herein are themselves amplified using methods known in the art.

Primers Used to Generate Libraries of the Invention

In one embodiment of the invention, non-mutagenic sets of primers used in the methods of the invention comprise a plurality of primers with different sequences. In a further embodiment, the non-mutagenic set of primers comprises at least 2 different sequences. In a still further embodiment, the non-mutagenic set of primers comprises from about 2 to about 200, from about 5 to about 150, from about 10 to about 100, from about 15 to about 75, from about 20 to about 50, and from about 30 to about 40 different sequences.

In another embodiment, mutagenic sets of primers used in methods of the invention comprise a plurality of primers with different sequences. In a further embodiment, the mutagenic sets of primers comprise at least 2 different sequences. In a further embodiment the mutagenic set of primers comprises from about 2 to about 200, from about 5 to about 150, from about 10 to about 100, from about 15 to about 75, from about 20 to about 50, and from about 30 to about 40 different sequences.

In one embodiment, primers within mutagenic sets of primers comprise at least one mis-matched nucleotide. By “mis-matched nucleotide” is meant a nucleotide within a primer that is not complementary to the corresponding location within the template nucleic acid. For example, a primer that is designed to anneal to a specific region of a nucleic acid template may contain a nucleotide at a position that is not complementary to the nucleotide in the corresponding location within that specific region of the nucleic acid template. This mis-matched nucleotide will thus result in an amplification product containing a point mutation in that location. In a further embodiment, mutagenic primers comprise at least two mis-matched nucleotides. In a still further embodiment, the mutagenic primers of the invention comprise from about 1 to about 50, from about 1 to 5, from about 5 to about 40, from about 10 to about 30, and from about 15 to about 20 mis-matched nucleotides. The number of mis-matched nucleotides in a mutagenic primer can be designed so that the resultant amplification products have a desired number of targeted mutations. The number of mis-matched nucleotides may also be influenced by the length of the primer and thus its ability to hybridize with the template. In a further embodiment, mutagenic primer sets of the invention comprise a plurality of primers containing different numbers of mis-matched nucleotides.

In one embodiment, amplification reactions used to generate libraries of the invention utilize a non-mutagenic primer set comprising primers that are all of identical sequence in combination with a mutagenic primer set comprising primers that are all of identical sequence or have at least 2 different sequences. The mutagenic and non-mutagenic primer sets may be directed to identical regions of the template sequence, or they may be directed to different regions of the template sequence.

In a further embodiment, the amplification reaction used to create the libraries of the invention utilizes only a mutagenic set of primers, such that all of the primers used in the amplification reaction comprise at least one mis-matched nucleotide that will result in targeted mutations in the resultant amplification products.

In one embodiment, the primers in the non-mutagenic and/or the mutagenic primer sets comprise one or more modified or non-natural nucleotides. Modifications can include, but are not limited to, those providing chemical groups that incorporate additional charge, polarizability, hydrogen bonding, electrostatic interaction, and fluxionality to the nucleic acid ligand bases or to the nucleic acid ligand as a whole. Such modifications can also include, but are not limited to, peptide nucleic acids (PNAs), phosphodiester group modifications (e.g., phosphorothioates, methylphosphonates), 2′-position sugar modifications, 5-position pyrimidine modifications, 8-position purine modifications, modifications at exocyclic amines, substitution of 4-thiouridine, substitution of 5-bromo or 5-iodo-uracil; backbone modifications, methylations, unusual base-pairing combinations such as the isobases, isocytidine and isoguanidine and the like. Non-natural nucleotides can include non-natural bases, such as, for example, nitroindole; such nucleotides may also be referred to as bases of non-naturally occurring nucleotide mono- and higher-phosphates. Modifications can also include 31 and 5′ modifications such as capping with a detectable label, such as a fluorescent moiety.

Mis-matched nucleotides in the mutagenic sets of primers used in the invention should have a minimal effect on the ability of these primers to anneal to the template nucleic acid, since the remainder of the primer's sequence will be perfectly complementary to the template.

Primers used in methods of the invention may be of any length that is effective for priming an amplification reaction. In one aspect, primers of the invention are designed to be of a length that is effective for efficient cycling between hybridization and elongation cycles. For example, shorter primers will result in shorter amplification products, which are more easily removed from the template than are longer primers and amplification products. In one exemplary embodiment, primers have a length of from about 5 to about 500, about 5 to about 20, about 10 to about 100, about 15 to about 250, about 30 to about 300, and about 40 to about 400 nucleotides.

Primers of the invention can be single or double-stranded. Double-stranded primers of the invention can be denatured before they are used in an amplification reaction that requires single stranded primers.

### Methods of Amplification for Generating Libraries of the Invention

Amplification reactions of use in the present invention include any reactions that are able to use primers to produce template-directed amplification products. A particularly useful amplification reaction is the polymerase chain reaction (PCR). Other non-PCR based target amplification reactions that can be used in the methods described herein include without limitation: isothermal transcription-based amplification (ITA) techniques that are based on either bacteriophage RNA polymerases or highly processive DNA polymerases.

In one embodiment, the amplification reaction used to generate libraries of the invention is PCR using a non-strand displacing polymerase. Non-strand displacing polymerases can be particularly useful in methods of the invention in which one or more extended primers are ligated to each other at the end of an amplification cycle, resulting in longer extension products than would otherwise be generated in a single cycle under similar conditions. Such longer extension products may in some exemplary embodiments be introduced in a subsequent or later cycle of the amplification reaction to further amplify the template nucleic acid.

### Template Nucleic Acids Used to Generate Libraries of the Invention

Template nucleic acids used in the methods of the invention may comprise DNA, RNA, or non-natural nucleotides and nucleotide analogs. These template nucleic acids may be derived from natural sources, such as cells and tissues, or they may be synthesized using methods known in the art.

Template nucleic acids used in the methods of the invention can be single or double-stranded. Double-stranded template nucleic acids can be denatured prior to their use in an amplification reaction that requires single-stranded templates.

In one embodiment, the template nucleic acids used to generate focused mutant libraries of the invention encode for a protein or a portion of a protein. As used herein, the term “protein” encompasses the term “polypeptide”. “Polypeptide” refers generally to a molecule comprising two or more amino acids, and a polypeptide may be a portion of a protein or an entire protein.

In a further embodiment, the template nucleic acids used to generate focused mutant libraries of the invention encode for an enzyme. In a still further embodiment, the template nucleic acids encode for a polymerase enzyme. In a still further embodiment, the polymerase enzyme is a DNA polymerase. DNA polymerases encoded by template nucleic acids may be polymerases known in the art and publicly available, or derivations thereof. For a review of polymerases, see, e.g., Hubscher et al. (2002) EUKARYOTIC DNA POLYMERASES Annual Review of Biochemistry Vol. 71: 133-163; Alba (2001) “Protein Family Review: Replicative DNA Polymerases” Genome Biology 2(1):reviews 3002.1-3002.4; and Steitz (1999) “DNA polymerases: structural diversity and common mechanisms” J Biol Chem 274:17395-17398, the disclosures of which are hereby expressly incorporated by reference in their entirety for all purposes, and in particular for the description of polymerases that may be fully or partially encoded by the focused mutant libraries of the invention.

### Uses of Libraries of the Invention

As described herein, mutant nucleic acid libraries of the invention can be used to generate mutant polypeptide libraries using methods known in the art. In one embodiment, mutant nucleic acid libraries of the invention are used to transform competent host cells to express the polypeptides encoded by the mutant nucleic acids. In another embodiment, the mutant nucleic acids are translated in vitro to yield the polypeptides encoded by the mutant nucleic acids.

Mutant polypeptide libraries generated from mutant nucleic acid libraries of the invention can be screened for desired characteristics using methods known in the art. The screening methods used will depend on the characteristic that is the focus of investigation. Generally, the present invention includes screening or selecting variant forms or expression products of mutant nucleic acids libraries of the invention for an altered or enhanced property relative to a template nucleic acid. For example, polypeptide libraries encoding proteins such as enzymes can be screened for characteristics such as stability, kinetics, thermodynamics, catalytic activity, substrate selectivity, response to environmental factors (including without limitation: photo-illumination, inhibitors, co-factors, temperature, pH), and other characteristics known in the art.

### Screening Libraries of Mutant Polymerase Enzymes made according to Methods of the Invention

In one embodiment, mutant polypeptide libraries of the invention include polymerase enzyme polypeptides. These libraries can be screened for one or more features of polymerase activity.

Mutant polymerases generated according to methods of the invention can include any of a variety of modified properties towards natural or nucleotide analogues or analogues, including increased speed, increased retention time (or decreased speed) for incorporated bases, greater processivity, etc. For example, where a higher level of nucleotide or nucleotide analogue incorporation is desired, the polymerase of the invention is selected to have a lower Kₘ, a higher Vmax and/or a higher k_{cat} than a corresponding homologous wild-type polymerase with respect to a given nucleotide analogue. In certain embodiments, it is desirable to slow or quicken the overall nucleotide incorporation speed of the polymerase (e.g., depending on the resolution of the equipment used to monitor incorporation), or to improve processivity, specificity, or the like. In certain embodiments, the recombinant polymerase has an increased rate of binding of a nucleotide or nucleotide analogue, an increased rate of product release, and/or a decreased branching rate, as compared to a corresponding homologous wild-type polymerase. Any of these features can be screened for or against in selecting a polymerase of the invention.

For example, mutant polymerases generated using methods of the invention can typically incorporate natural nucleotides (e.g., A, C, G and T) into a growing copy nucleic acid. Such enzymes may display a specific activity for a nucleotide that is at least about 5% as high (e.g., 5%, 10%, 25%, 50%, 75%, 100% or higher) as a corresponding homologous wild-type polymerase and a processivity with nucleotides in the presence of a template that is at least 5% as high (e.g., 5%, 10%, 25%, 50%, 75%, 100% or higher) as the wild-type polymerase in the presence of the nucleotide. Optionally, the mutant polymerases may also display a k_{cat}/Kₘ or Vₘₐₓ/Kₘ for a naturally occurring nucleotide that is at least about 10% as high (e.g., 10%, 25%, 50%, 75% or 100% or higher) as the wild-type polymerase.

As is well-known in the art, for enzymes obeying simple Michaelis-Menten kinetics, kinetic parameters are readily derived from rates of catalysis measured at different substrate concentrations. The Michaelis-Menten equation, V=Vₘₐₓ[S]([S]+Kₘ)⁻¹, relates the concentration of uncombined substrate ([S], approximated by the total substrate concentration), the maximal rate (Vₘₐₓ, attained when the enzyme is saturated with substrate), and the Michaelis constant (Kₘ, equal to the substrate concentration at which the reaction rate is half of its maximal value), to the reaction rate (V).

For many enzymes, Kₘ is equal to the dissociation constant of the enzyme-substrate complex and is thus a measure of the strength of the enzyme-substrate complex. For such an enzyme, in a comparison of Kₘs, a lower Kₘ represents a complex with stronger binding, while a higher Km represents a complex with weaker binding. The ratio k_{cat}/Kₘ, sometimes called the specificity constant, represents the apparent rate constant for combination of substrate with free enzyme. The larger the specificity constant, the more efficient the enzyme is in binding the substrate and converting it to product.

The k_{cat} (also called the turnover number of the enzyme) can be determined if the total enzyme concentration ([E_{T}], i.e., the concentration of active sites) is known, since Vₘₐₓ=k_{cat}[E_{T}]. For situations in which the total enzyme concentration is difficult to measure, the ratio Vₘₐₓ/Kₘ is often used instead as a measure of efficiency. Kₘ and Vₘₐₓ can be determined, for example, from a Lineweaver-Burk plot of 1/V against 1/[S], where the y intercept represents 1/Vₘₐₓ, the x intercept −1/Kₘ, and the slope Kₘ/Vₘₐₓ, or from an Eadie-Hofstee plot of V against V/[S], where the y intercept represents Vₘₐₓ, the x intercept Vₘₐₓ/Kₘ, and the slope −Kₘ. Software packages such as KinetAsyst™ or Enzfit (Biosoft, Cambridge, UK) can facilitate the determination of kinetic parameters from catalytic rate data.

For enzymes such as polymerases that have multiple substrates, varying the concentration of only one substrate while holding the others in suitable excess (e.g., effectively constant) concentration typically yields normal Michaelis-Menten kinetics.

In one embodiment, using presteady-state kinetics, the nucleotide concentration dependence of the rate k_{obs} (the observed first-order rate constant for dNTP incorporation) provides an estimate of the Kₘ for a ground state binding and the maximum rate of polymerization (kₚₒₗ). The k_{obs} is measured using a burst assay. The results of the assay can be fitted with the burst equation; Product=A[1−exp(−k_{obs}*t)]+kₛₛ*t where A represents amplitude an estimate of the concentration of the enzyme active sites, kₛₛ is the observed steady-state rate constant and t is the reaction incubation time. The Kₘ for dNTP binding to the polymerase-DNA complex and the kₚₒₗ are calculated by fitting the dNTP concentration dependent change in the k_{obs} using the equation k_{obs}=(kₚₒₗ*[S])*(Kₘ+[S])−1 where [S] is the substrate concentration. Results are optionally obtained from a rapid-quench experiment (also called a quench-flow measurement), for example, based on the methods described in Johnson (1986) “Rapid kinetic analysis of mechanochemical adenosinetriphosphatases” Methods Enzymol. 134:677-705, Patel et al. (1991) “Pre-steady-state kinetic analysis of processive DNA replication including complete characterization of an exonuclease-deficient mutant” Biochemistry 30(2):511-25, and Tsai and Johnson (2006) “A new paradigm for DNA polymerase specificity” Biochemistry 45(32):9675-87.

Parameters such as rate of binding of a nucleotide or nucleotide analogue by a mutant polymerase, rate of product release by the mutant polymerase, or branching rate of the mutant polymerase (the “branching rate” is the rate of dissociation of a nucleotide or nucleotide analogue from the polymerase active site without incorporation of the nucleotide or nucleotide analogue, where the nucleotide or nucleotide analogue if it were incorporated would correctly base-pair with a complementary nucleotide or nucleotide analogue in the template) can also be determined, and optionally compared to that of the first polymerase (e.g., a corresponding wild-type polymerase).

In one aspect, the activity of the mutant polymerases in libraries of the invention is measured with reference to a model analogue or analogue set and compared with a given parental enzyme.

In one aspect, a plurality of members of a mutant polymerase library made according to the invention can include one or more putative steric inhibition feature mutations and/or a mutation to putatively produce complementary with one or more features of a nucleotide or a nucleotide analogue. In general, the library can be screened to identify at least one member comprising a modified activity of interest.

Libraries of polymerases can be either physical or logical in nature. Moreover, any of a wide variety of library formats can be used. For example, polymerases can be fixed to solid surfaces in arrays of proteins. Similarly, liquid phase arrays of polymerases (e.g., in microwell plates) can be constructed for convenient high-throughput fluid manipulations of solutions comprising polymerases. Liquid, emulsion, or gel-phase libraries of cells that express recombinant polymerases can also be constructed, e.g., in microwell plates, or on agar plates. Phage display libraries of polymerases or polymerase domains (e.g., including the active site region) can be produced from polypeptide libraries generated as described herein.

### Kits

In one aspect, the invention provides kits that incorporate mutagenic and non-mutagenic primers as described herein. Depending upon the desired application, the kits of the invention optionally include additional reagents, such as natural or non-natural nucleotides, a control template, and other reagents, such as buffer solutions and/or salt solutions, including, e.g., divalent metal ions, i.e., Mg⁺⁺, Mn⁺⁺ and/or Fe⁺⁺, standard solutions, e.g., dye standards for detector calibration. Such kits also typically include instructions for use of the compounds and other reagents in accordance with the desired application methods. In a further aspect kits of the invention may also include one or more thermostable ligases. In a still further aspect, kits of the invention may also include components for removing amplification products from the remainder of an amplification reaction mixture. In a still further aspect, the kits of the invention may include nucleases to remove non-amplified template nucleic acid strands as well as generic primers with 5′ modifications to block action by such nucleases.

Although described in some detail for purposes of illustration, it will be readily appreciated that a number of variations known or appreciated by those of skill in the art may be practiced within the scope of present invention. Unless otherwise clear from the context or expressly stated, any concentration values provided herein are generally given in terms of admixture values or percentages without regard to any conversion that occurs upon or following addition of the particular component of the mixture. To the extent not already expressly incorporated herein, all published references and patent documents referred to in this disclosure are incorporated herein by reference in their entirety for all purposes.

What is claimed is:

1. A method of producing a library of mutated nucleic acids, said method comprising:
providing a single-stranded template nucleic acid comprising a first sequence of nucleotides;
providing a first set of primers, wherein a majority of said first set of primers are perfectly complementary to at least a portion of said first sequence of nucleotides;
providing a second set of primers, wherein a majority of said second set of primers are complementary to at least a portion of said first sequence of nucleotides except for at least one pre-selected mismatched nucleotide complementary to at least one targeted mutation;
combining said template nucleic acid with said first set of primers and said second set of primers under conditions suitable for amplification of said template nucleic acid; and
amplifying said template nucleic acid to produce said library of mutated nucleic acids, wherein said mutated nucleic acids have at least one targeted mutation therein.

2. The method of claim 1, wherein said majority of said first set of primers comprises a first plurality of primers with different sequences.

3. The method of claim 2, wherein said first plurality of primers comprises at least 2 different sequences.

4. The method of claim 2, wherein said first plurality of primers comprises at least 10 different sequences.

5. The method of claim 2, wherein said first plurality of primers comprises at least 50 different sequences.

6. The method of claim 1, wherein said majority of said second set of primers comprises a second plurality of primers with different sequences.

7. The method of claim 6, wherein said second plurality of primers comprises at least 2 different sequences.

8. The method of claim 6, wherein said second plurality of primers comprises at least 10 different sequences.

9. The method of claim 6, wherein said second plurality of primers comprises at least 50different sequences.

10. The method of claim 1, wherein said library of mutated nucleic acids encode for at least a portion of an enzyme polypeptide.

11. The method of claim 10, wherein said enzyme polypeptide is a polymerase enzyme polypeptide.

12. The method of claim 1, wherein said amplifying comprises conducting a polymerase chain reaction.

13. The method of claim 12, wherein said polymerase chain reaction is conducted using a non-strand displacing DNA polymerase.

14. The method of claim 1, wherein said first set of primers and said second set of primers are provided in a pre-defined ratio so as to bias said library of mutant nucleic acids.

15. The method of claim 1 further comprising:
transforming at least one of said library of mutant nucleic acids into a competent host cell to provide an expressed protein; and
screening said expressed protein for desired characteristics.

16. The method of claim 1 further comprising:
translating at least one of said plurality of mutant nucleic acid molecules from said library in vitro to yield an expressed protein; and
screening said expressed protein for desired characteristics.

17. The method of claim 1, further comprising expressing said library of mutant nucleic acids to provide a library of mutant polypeptides.

18. The method of claim 17, wherein said library of mutant polypeptides comprise enzyme polypeptides.

19. The method of claim 18, wherein said enzyme polypeptides comprises polymerase polypeptides.

20. A method of generating a library of polynucleotide molecules, wherein said polynucleotide molecules encode at least a portion of a mutant enzyme, said method comprising:
contacting at least one single-stranded template polynucleotide with a set of primers, wherein said set of primers comprises:
at least one primer perfectly complementary to at least a portion of said template polynucleotide; and
a plurality of mutant primers, wherein each of said plurality of mutant primers comprises at least one pre-selected mismatched nucleotide complementary to at least one targeted mutation;
conducting a multi-cycle polynucleotide extension reaction with said at least one template polynucleotide and said set of primers, wherein:
in at least one cycle, said primers anneal to said at least one template polynucleotide and prime replication of said at least one template polynucleotide, thereby generating a pool comprising overlapping fragments, wherein said overlapping fragments are shorter in length than said at least one template polynucleotide and wherein said overlapping fragments overlap to span said at least one template polynucleotide molecule;
in at least one subsequent cycle, said overlapping fragments generated in a previous cycle anneal in new combinations to said at least one template polynucleotide molecule, thereby forming annealed fragments, wherein said annealed fragments prime replication of said at least one template polynucleotide molecule to form a further pool of overlapping fragments; and
wherein said multi-cycle polynucleotide extension reaction is continued for a sufficient number of cycles such that said further pool of overlapping fragments includes variant forms of said at least one template polynucleotide molecule,
thereby generating said library of polynucleotide molecules.

21. The method of claim 20, said method further comprising: (c) screening or selecting said variant forms of said at least one template polynucleotide molecule, or expression products thereof, for an altered or enhanced property relative to said at least one template polynucleotide or an expression product thereof.

22. The method of claim 20 further comprising amplifying said variant forms of said at least one template polynucleotide molecule.

23. The method of claim 20, wherein said polynucleotide extension is conducted under conditions such that said primers annealed to said at least one template polynucleotide molecule are extended by less than a pre-determined number nucleotides.

24. The method of claim 20, wherein said plurality of mutant primers comprise different sequences.

25. The method of claim 24, wherein said plurality of mutant primers comprise at least 5 different sequences.
